(19) United States
(12) Patent Application Publication
(10) Pub. No.: US 2011/0294043 A1
(43) Pub. Date: Dec. 1, 2011

(54) ELECTRODE FOR FUEL CELL AND FUEL CELL EMPLOYING THE SAME

(75) Inventors: Tae-young KIM, Seoul (KR); Jung-seok Yi, Seoul (KR); Pil-won Heo, Yongin-si (KR)

(73) Assignee: Samsung Electronics Co., Ltd., Suwon-si (KR)

(21) Appl. No.: 13/081,667

(22) Filed: Apr. 7, 2011

(30) Foreign Application Priority Data
May 28, 2010 (KR) 10-2010-0050346

(51) Int. Cl. H01M 4/92; H01M 4/64; H01M 4/62

(52) U.S. Cl. 429/521; 429/532; 429/524

(57) ABSTRACT

Electrodes for fuel cells including a quadrivalent metal element, a monovalent metal element or a divalent metal element, and phosphates, as well as fuel cells including the electrodes.

### CROSS-REFERENCE TO RELATED APPLICATION

This application claims the benefit of Korean Patent Application No. 10-2010-0050346, filed on May 28, 2010 in the Korean Intellectual Property Office, the disclosure of which is incorporated herein by reference.

### BACKGROUND

1. Field

Aspects of the present disclosure relate to electrodes for fuel cells and to fuel cells including the same.

2. Description of the Related Art

Fuel cells can be classified into polymer electrolyte membrane fuel cells (PEMFCs), direct methanol fuel cells (DMFCs), phosphoric acid fuel cells (PAFCs), molten carbonate fuel cells (MCFCs), and solid oxide fuel cells (SOFCs) according to the types of electrolyte and fuel used in the fuel cells. Operating temperatures and properties of the components of fuel cells vary depending on the electrolytes used.

PEMFCs that are operated at high temperatures of at least 100° C. in a non-humid environment do not use a humidifying device compared with PEMFCs operated at low temperatures. Accordingly, water may be easily controlled and reliability of such a system increases. Also, a humidifying device is not needed and a reformer may be simplified because such an electrode has increased tolerance against CO poisoning that otherwise can occur in high temperature operations. Accordingly, there has been interest in a high-temperature non-humidity system.

Currently, acid doping based membrane electrode assemblies (MEAs) have been commercialized as MEAs for high-temperature and non-humidity PEMFCs. Non-acid doping based MEAs have not yet been commercialized but research thereon has been performed.

Among acid doping based MEAs, in a phosphoric acid doping based MEA, a phosphoric acid distributed in an electrode functions as the main ion conductor. Accordingly, performance of the MEA varies according to the distribution of the phosphoric acid and the amount of the phosphoric acid in the electrode. As the phosphoric acid is disposed in pores of the electrode, the distribution of the phosphoric acid may first be determined according to the initial air gap volume and distribution.

The distribution of the phosphoric acid may vary according to current density, gas flow rate, temperature, and the like, while a fuel cell is operating. For example, water generated from an air electrode changes the concentration of the phosphoric acid. In this regard, since the distribution and amount of phosphoric acid in the electrode continuously change due to changing operating conditions while the fuel cell is operating, it is difficult to control the distribution of the phosphoric acid. Such a change in the distribution of the phosphoric acid also changes the use rate of a catalyst and thus affects performance of the fuel cell. When the fuel cell is repeatedly stopped, moisture generated while operating the fuel cell is condensed and the concentration of the phosphoric acid is reduced, thereby accelerating leakage of the phosphoric acid. Consequently, performance of the fuel cell may be reduced and the lifetime thereof may be reduced.

### SUMMARY

Electrodes for fuel cells having excellent proton conductivity characteristics and fuel cells including the same are provided.

According to an aspect of the present invention, an electrode for a fuel cell includes an inorganic proton conductor represented by Formula 1 below.

M₁₋ₐNₐP₂O₇ [Formula 1]

wherein, M is a quadrivalent metal element, N is at least one ion selected from the group consisting of group 1 metal elements and group 2 metal elements, and a is in the range of about 0.01 to about 0.7.

According to another aspect of the present invention, a fuel cell includes that electrode for a fuel cell.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects of the invention will become apparent and more readily appreciated from the following description of the embodiments, taken in conjunction with the accompanying drawings, of which:

FIG. 1A illustrates the crystal structure of Sn₁₋ₐLiₐP₂O₇;

FIG. 1B is a diagram for explaining proton concentration increases in the crystal structure of FIG. 1A;

FIG. 2 is a graph showing results of X-ray diffraction analysis for inorganic proton conductors manufactured according to Examples 1, 7, and 8;

FIG. 3 is a graph showing conductivity characteristics of inorganic proton conductors manufactured according to Examples 1, 7, 8, and 9;

FIG. 4 is a graph illustrating voltage characteristics as a function of current density in fuel cells manufactured according to Manufacturing Example 1 and Comparative Manufacturing Example 1;

FIGS. 5A and 5B are graphs showing AC impedance characteristics in fuel cells manufactured according to Manufacturing Example 1 and Comparative Manufacturing Example 1; and

FIG. 6 is a graph illustrating proton resistance characteristics in electrodes of fuel cells manufactured according to Manufacturing Example 1 and Comparative Manufacturing Example 1.

### DETAILED DESCRIPTION

Reference will now be made in detail to the present embodiments of the present invention, examples of which are illustrated in the accompanying drawings. The embodiments are described below in order to explain the present invention by referring to the figures.

An electrode for a fuel cell including an inorganic proton conductor represented by Formula 1 below is provided.

M₁₋ₐNₐP₂O₇ [Formula 1]

In Formula 1, M is a quadrivalent metal element, N is at least one ion selected from the group consisting of group 1 metal elements and group 2 metal elements, and a is in the range of about 0.01 to about 0.7.

M is a positive quadrivalent metal ion and may include at least one ion selected from the group of elements consisting of tin (Sn), zirconium (Zr), tungsten (W), silicon (Si), molybdenum (Mo), and titanium (Ti).

N may include, for example, at least one ion selected from the group of elements consisting of lithium (Li), sodium (Na), potassium (K), cesium (Cs), beryllium (Be), magnesium (Mg), calcium (Ca), strontium (Sr), and barium (Ba).

The inorganic proton conductor represented by Formula 1 has a structure in which a portion of M, which forms a quadrivalent positive ion, is substituted with N, which forms a monovalent metal ion or a divalent metal ion.

In Formula 1, a may be in the range of about 0.05 to about 0.5, for example, about 0.1 to about 0.4.

M and N may be Sn and Li, respectively, and the inorganic proton conductor may be, for example, Sn₁₋ₐLiₐP₂O₇.

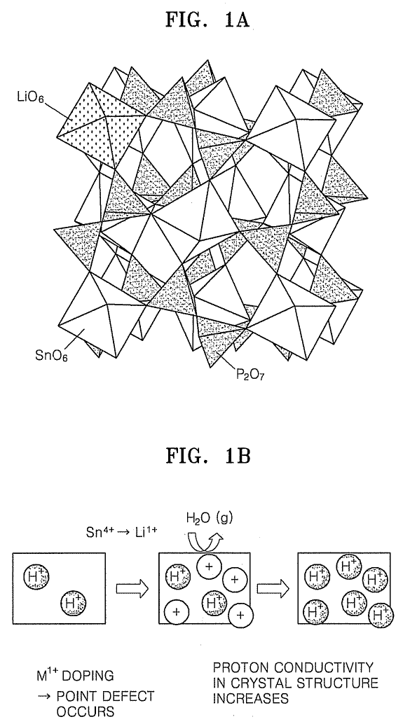

FIG. 1A illustrates the crystal structure of Sn₁₋ₐLiₐP₂O₇, which is an example of the inorganic proton conductor represented by Formula 1, and FIG. 1B is a diagram for explaining proton concentration increases in the crystal structure of FIG. 1A.

Referring to FIGS. 1A and 1B, Sn₁₋ₐLiₐP₂O₇ has a structure in which Sn⁴⁺ of SnP₂O₇ (tin phosphate) is substituted with a monovalent metal ion (Li+, Na+, K+, or Cs+). As such, an alkali metal ion, which is a monovalent metal ion, is doped into tin phosphate so that point defects may occur and proton concentration in the crystal structure may increase. Also, if the doping material is an alkali metal instead of another metal, bonding strength with the phosphoric acid increases and thus excellent conductivity may be maintained at high temperatures.

When a is in the range of about 0.1 to about 0.3, Sn₁₋ₐLiₐP₂O₇ has a main phase crystal structure, and when a is in the range of about 0.4 to about 0.5, lithium exceeds its solubility limit and a new phase, that is, a lithium second phase, may be observed.

The inorganic proton conductor represented by Formula 1 may be, for example, Sn_{0.7}Li_{0.3}P₂O₇, Sn_{0.95}Li_{0.05}P₂O₇, Sn_{0.9}Li_{0.1}P₂O₇, Sn_{0.8}Li_{0.2}P₂O₇, Sn_{0.6}Li_{0.4}P₂O₇, Sn_{0.5}Li_{0.5}P₂O₇, Sn_{0.7}Na_{0.3}P₂O₇, Sn_{0.7}K_{0.3}P₂O₇, Sn_{0.7}Cs_{0.3}P₂O₇, Zr_{0.9}Li_{0.1}P₂O₇, Ti_{0.9}Li_{0.1}P₂O₇, Si_{0.9}Li_{0.1}P₂O₇, Mo_{0.9}Li_{0.1}P₂O₇, W_{0.9}Li_{0.1}P₂O₇, Sn_{0.7}Mg_{0.3}P₂O₇, Sn_{0.95}Mg_{0.05}P₂O₇, Sn_{0.9}Mg_{0.1}P₂O₇, Sn_{0.8}Mg_{0.2}P₂O₇, Sn_{0.6}Mg_{0.4}P₂O₇, Sn_{0.5}Mg_{0.5}P₂O₇, Sn_{0.7}Ca_{0.3}P₂O₇, Sn_{0.7}Sr_{0.3}P₂O₇, Sn_{0.7}Ba_{0.3}P₂O₇, Zr_{0.9}Mg_{0.1}P₂O₇, Ti_{0.9}Mg_{0.1}P₂O₇, Si_{0.9}Mg_{0.1}P₂O₇, Mo_{0.9}Mg_{0.1}P₂O₇, W_{0.9}Mg_{0.1}P₂O₇, Zr_{0.7}Mg_{0.3}P₂O₇, Ti_{0.7}Mg_{0.3}P₂O₇, Si_{0.7}Mg_{0.3}P₂O₇, Mo_{0.7}Mg_{0.3}P₂O₇, or W_{0.7}Mg_{0.3}P₂O₇.

A method of preparing the inorganic proton conductor represented by Formula 1 is described below. First, a precursor of M, a precursor of N, and a phosphoric acid are mixed together to prepare an initial mixture. Then, a solvent is mixed into the initial mixture, thereby preparing a composition for forming the inorganic proton conductor represented by Formula 1.

The solvent may be, for example, deionized water, methanol, ethanol, or isopropyl alcohol, and the amount of the solvent may be in the range of about 300 to about 800 parts by weight based on 100 parts by weight of the M precursor. When the amount of the solvent is in the range described above, viscosity of the composition is appropriate, thereby improving workability.

The composition is stirred at a temperature in the range of about 200 to about 30° C. When such a stirring process is performed at a temperature in the temperature range described above, components for forming the composition are uniformly mixed to remove the solvent from the composition so that appropriate viscosity may be maintained in the composition. As such, when the viscosity of the composition is appropriately controlled, the next heat treatment may be efficiently performed without phase separation of the composition.

Then, the resultant is heat treated at a temperature in the range of about 300 to about 1200° C. and the resulting solid is pulverized into a powder having particles of a predetermined size, thereby obtaining the inorganic proton conductor represented by Formula 1.

The M precursor may be, for example, an M oxide, an M chloride, or an M hydroxide, and more specifically, at least one selected from the group consisting of tin oxide (SnO₂), tin chloride (SnCl₄, SnCl₂), tin hydroxide (Sn(OH)₄), tungsten oxide (WO₂, WO₃), tungsten chloride (WCl₄), molybdenum oxide (MoO₂), molybdenum chloride (MoCl₃), zirconium oxide (ZrO₂), zirconium chloride (ZrCl₄), zirconium hydroxide (Zr(OH)₄), titanium oxide (TiO₂), and titanium chloride (TiCl₂, TiCl₃).

The N precursor may be, for example, an N oxide, an N chloride, or an N hydroxide and more specifically, lithium hydroxide (LiOH.H₂O), lithium oxide (Li₂O), lithium chloride (LiCl), lithium nitrate (LiNO₃), sodium hydroxide (NaOH), sodium chloride (NaCl), potassium hydroxide (KOH), potassium chloride (KCl), potassium hydroxide (KOH), cesium hydroxide (CsOH.H₂O), cesium chloride (CsCl), beryllium chloride (BeCl₂), magnesium hydroxide (Mg(OH)₂), magnesium oxide (MgO), calcium hydroxide (Ca(OH)₂), calcium chloride (CaCl₂), strontium hydroxide (Sr(OH)₂), strontium chloride (SrCl₂), barium hydroxide (Ba(OH)₂), barium chloride (BaCl₂)), or mixtures thereof.

The amount of the N precursor may be in the range of about 5 to about 50 mol % based on the total amount of the M precursor and the N precursor. When the amount of the N precursor is in the described-above range, the inorganic proton conductor represented by Formula 1 may be obtained.

The phosphoric acid may be a phosphoric acid aqueous solution in the range of about 80 to about 100 weight % and the amount of the phosphoric acid in the range of about 200 to about 300 parts by weight based on 100 parts by weight of the M precursor when using 85 weight % of a phosphoric acid aqueous solution. When the amount of the phosphoric acid is in the described-above range, the inorganic proton conductor represented by Formula 1 may be easily obtained in consideration of an amount of phosphoric acid loss.

When the heat treatment temperature of the composition is in the described-above range, the inorganic proton conductor represented by Formula 1 having excellent proton conductivity may be obtained without transformation of the crystal structure. The time for the heat treatment may vary according to the heat treatment temperature. For example, the heat treatment may be performed for about 1 to about 5 hours.

The heat treatment may be performed under an inert gas atmosphere such as nitrogen or an air atmosphere. When pulverizing the heat treated resultant into powder, the particle diameter is not particularly restricted; however, the particle diameter may be adjusted to be about 50 to about 5000 nm.

The inorganic proton conductor represented by Formula 1 may be included in a catalyst layer of an electrode that incorporates a catalyst.

The catalyst may be, for example, a catalyst metal such as platinum (Pt) or an alloy of platinum (Pt) and at least one metal selected from the group consisting of gold, palladium, rhodium, iridium, ruthenium, tin, molybdenum, cobalt, and chromium. The catalyst may also be a support catalyst in which the catalyst metal is supported by a carbon-based support.

For example, the catalyst may be at least one catalyst metal selected from the group consisting of platinum (Pt), platinum cobalt (PtCo), and platinum ruthenium (PtRu) or a support catalyst in which the at least one catalyst metal is supported by a carbon-based support.

The inorganic proton conductor may be supported or coated on conductive carbon. In such a structure, even if a large amount of the inorganic proton conductor is used, electrical conductivity of the electrode may be maintained.

When the catalyst is a catalyst metal supported by a carbon-based support, the inorganic proton conductor may be supported by the carbon-based support along with the catalyst metal. When the inorganic proton conductor has such a structure, the electrode may be more effective due to the addition of the inorganic proton conductor.

When the catalyst including the catalyst metal and the inorganic proton conductor supported by the carbon-based support is used to prepare an electrode catalyst layer, the inorganic proton conductor represented by Formula 1 may improve the conductivity of the electrode.

The electrode catalyst may further include a binder generally used in preparing an electrode for a fuel cell.

The binder may be, for example, at least one polymer selected from the group consisting of poly(vinylidene fluoride), polytetrafluoroethylene, and tetrafluoroethylene-hexafluoro propylene copolymer.

The amount of the binder may be in the range of about 0.02 to about 0.05 parts by weight based on 1 part by weight of the electrode catalyst. When the amount of the binder is in that range, the binding capacity of the electrode catalyst with respect to the support is excellent.

The amount of the inorganic proton conductor may be in the range of about 5 to about 40 parts by weight based on 100 parts by weight of a total amount of solid contents of the catalyst layer. For example, when the solid content of the catalyst layer includes the electrode catalyst, the inorganic proton conductor, and the binder, the solid content of the catalyst layer represents the total amount of the electrode catalyst, the inorganic proton conductor, and the binder.

For example, the amount of the inorganic proton conductor may be in the range of about 0.05 to about 0.7 parts by weight based on 1 part by weight of the catalyst.

When the amount of the inorganic proton conductor is in the described-above range, proton conductivity and moisture adsorption characteristics of the electrode are excellent.

A method of preparing an electrode for a fuel cell using the inorganic proton conductor represented by Formula 1 is described below. When preparing the composition for forming the electrode catalyst layer, the electrode catalyst, the inorganic proton conductor, the binder, and the solvent are not limited to being added in an order described by the following process and the order may vary as long as each component may be uniformly mixed in the composition.

First, the catalyst is dispersed in a solvent so as to prepare a dispersion solution. Here, the solvent may be N-methylpyrrolidone (NMP) or dimethylacetamide (DMAc) and the amount thereof is in the range of about 1 to about 10 parts by weight based on 1 part by weight of the catalyst.

The inorganic proton conductor represented by Formula 1 and the binder are mixed into the dispersion solution to prepare a mixture solution. The mixture solution is stirred to prepare a composition for forming an electrode catalyst layer.

The composition for forming an electrode catalyst layer is coated on a carbon support so as to complete manufacture of the electrode. Here, the carbon support may be fixed to a glass substrate to facilitate the coating process. The coating process is not particularly restricted. For example, coating using a doctor blade, bar coating, or screen printing may be used.

After the composition for forming an electrode catalyst layer is coated on the carbon support, a drying process is performed to remove the solvent. The drying process is performed at a temperature in the range of about 20 to about 150° C. and the time for the drying process may vary according to the drying temperature, for example, about 10 to about 60 minutes.

The electrode prepared as above may be used as a cathode or an anode. For example, the electrode prepared as above is used as the cathode. A fuel cell is manufactured by using the cathode and a conventional anode. The anode is impregnated with a proton conductor.

The proton conductor may be polyphosphoric acid, phosphonic acid (H₃PO₃), orthophosphoric acid (H₃PO₄), pyrophosphoric acid (H₄P₂O₇), triphosphoric acid (H₅P₃O₁₀), metaphosphoric acid, or an organic phosphonic acid or derivative thereof. The concentration of the proton conductor may be at least 80 weight %, 85 weight %, 90 weight %, 95 weight %, or 98 weight %. For example, when phosphoric acid is used, 85 weight % of a phosphoric acid aqueous solution is used and the time for phosphoric acid impregnation is in the range of about 2.5 to about 14 hours at about 8° C.

The amount of the proton conductor may be in the range of about 10 to about 1000 parts by weight based on 100 parts by weight of the electrode.

The electrode for a fuel cell includes the inorganic proton conductor represented by Formula 1 and thus has excellent proton conductivity over a wide temperature range and an excellent moisture absorption characteristic. Accordingly, when such an electrode is used, sensitivity to a change in moisture generation due to the operating conditions of the electrode may be reduced and thus the performance of a fuel cell, for example, a phosphoric acid doping based fuel cell, may be stably maintained.

Hereinafter, a method of preparing a fuel cell including the above electrode for a fuel cell is described below. The electrode for a fuel cell prepared as described above is disposed on both surfaces of an electrolyte membrane and is bonded thereon at a high temperature and at a high pressure so as to prepare a membrane electrode assembly (MEA). A fuel diffusion layer may be bonded to the MEA. Here, the heating temperature and pressure for the bonding process may be a temperature at which the electrolyte membrane is softened and a pressure of about 0.1 to about 3 ton/cm², for example, about 1 ton/cm², respectively.

Then, a bipolar plate is mounted on the MEA, thereby completing manufacture of the fuel cell. Here, the bipolar plate has a groove for supplying fuel and functions as a current collector. That is, the fuel cell is manufactured by using the MEA. Then, air and hydrogen fuel are injected thereto to operate the fuel cell.

The electrolyte membrane may be any electrolyte membrane that is commonly used in a fuel cell. For example, the electrolyte membrane may be a polybenzimidazole electrolyte membrane, a polybenzoxazine-polybenzimidazole copolymer electrolyte membrane, or a polytetrafluorethylene (PTFE) porous membrane.

A proton conductor may be further impregnated with the electrolyte membrane. The proton conductor may be polyphosphoric acid, phosphonic acid (H₃PO₃), orthophosphoric acid (H₃PO₄), pyrophosphoric acid (H₄P₂O₇), triphosphoric acid (H₃P₃O₁₀), metaphosphoric acid, or an organic phosphonic acid or derivative thereof. The concentration of the proton conductor may be at least 80 weight %, 85 weight %, 90 weight %, 95 weight %, or 98 weight %.

A method of preparing an electrolyte membrane using one or two types of polymerization products of the benzoxazine based monomer is disclosed in US 2009-0117436A.

Use of a fuel cell is not particularly restricted. However, according to an embodiment of the present invention, a fuel cell may be used as a polymer electrolyte membrane fuel cell.

The electrolyte using the inorganic proton conductor is efficiently used in a non-humidity type proton conductor and a fuel cell operated under a mid-temperature in a non-humid environment. Here, the “mid-temperature” is not particularly restricted. However, according to an embodiment of the present invention, the mid-temperature is in the range of about 150 to about 400° C.

The disclosed embodiments will be described in further detail with reference to the following examples. The following examples are for illustrative purposes only and are not intended to limit the scope of the invention.

### Example 1

### Preparation of Inorganic Proton Conductor

SnO₂, LiOH.H₂O, and 85 weight % of H₃PO₄ were mixed with each other to have a mole ratio of Sn, Li, and P to be 0.7:0.3:2-3. Ion exchange water was added to the mixture and the mixture was stirred to obtain a mixed paste having a high viscosity. Here, the amount of LiOH.H₂O was 30 mol % and amount of SnO₂ was 70 mol %. The obtained paste was thermally treated in an alumina crucible for about 2.5 hours at about 65° C. The solid obtained after the thermal treatment was pulverized using a mortar to obtain Sn_{0.7}Li_{0.3}P₂O₇ in a powder state.

The composition of Sn_{0.7}Li_{0.3}P₂O₇ was identified using inductively coupled plasma atomic emission spectroscopy (ICP-AES). Because of the loss of some phosphoric acid during the thermal treatment, the final chemical stoichiometric composition was Sn_{0.7}Li_{0.3}P₂O₇ (Sn:Li:P=0.7:0.3:2).

### Example 2

### Preparation of Inorganic Proton Conductor

Sn_{0.95}Li_{0.05}P₂O₇ was synthesized in the same manner as in Example 1, except that 5 mol % of LiOH.H₂O was used for the mole ratio of Sn, Li, and P to be 0.95:0.05:2-3.

### Example 3

### Preparation of Inorganic Proton Conductor

Sn_{0.9}Li_{0.1}P₂O₇ was synthesized in the same manner as in Example 1, except that 10 mol % of LiOH.H₂O was used for the mole ratio of Sn, Li, and P to be 0.9:0.1:2-3.

### Example 4

### Preparation of Inorganic Proton Conductor

Sn_{0.8}Li_{0.2}P₂O₇ was synthesized in the same manner as in Example 1, except that 20 mol % of LiOH.H₂O was used for the mole ratio of Sn, Li, and P to be 0.8:0.2:2-3.

### Example 5

### Preparation of Inorganic Proton Conductor

S_{0.5}Li_{0.5}P₂O₇ was synthesized in the same manner as in Example 1, except that 40 mol % of LiOH.H₂O was used for the mole ratio of Sn, Li, and P to be 0.6:0.4:2-3.

### Example 6

### Preparation Of Inorganic Proton Conductor

Sn_{0.5}Li_{0.5}P₂O₇ was synthesized in the same manner as in Example 1, except that 50 mol % of LiOH.H₂O was used for the mole ratio of Sn, Li, and P to be 0.5:0.5:2-3.

### Example 7

### Preparation of Inorganic Proton Conductor

Sn_{0.7}Na_{0.3}P₂O₇ was synthesized in the same manner as in Example 1, except that NaOH was used instead of LiOH.H₂O.

### Example 8

### Preparation of Inorganic Proton Conductor

Sn_{0.7}K_{0.3}P₂O₇ was synthesized in the same manner as in Example 1, except that KOH was used instead of LiOH.H₂O.

### Example 9

### Preparation of Inorganic Proton Conductor

Sn_{0.7}Cs_{0.3}P₂O₇ was synthesized in the same manner as in Example 1, except that CsOH was used instead of LiOH.H₂O.

### Example 10

### Preparation of Inorganic Proton Conductor

Zr_{0.9}Li_{0.1}P₂O₇ was synthesized in the same manner as in Example 1, except that ZrO₂ was used instead of SnO₂, and ZrO₂, LiOH.H₂O, and 85 weight % of H₃PO₄ were mixed together to have a mole ratio of 0.9:0.1:2-3.

### Example 11

### Preparation of Inorganic Proton Conductor

Ti_{0.9}Li_{0.1}P₂O₇ was synthesized in the same manner as in Example 10, except that TiO₂ was used instead of ZrO₂.

### Example 12

### Preparation of Inorganic Proton Conductor

Si_{0.9}Li_{0.1}P₂O₇ was synthesized in the same manner as in Example 10, except that SiO₂ was used instead of ZrO₂.

### Example 13

### Preparation of Inorganic Proton Conductor

Mo_{0.9}Li_{0.1}P₂O₇ was synthesized in the same manner as in Example 10, except that MoO₂ was used instead of ZrO₂.

### Example 14

### Preparation of Inorganic Proton Conductor

W_{0.9}Li_{0.1}P₂O₇ was synthesized in the same manner as in Example 10, except that WO₃ was used instead of ZrO₂.

### Comparative Example 1

### Preparation of Sn_{0.9}In_{0.1}P₇O₇

Sn_{0.9}In_{0.1}P₂O₇ was synthesized in the same manner as in Example 1, except that In₂O₃ was used instead of LiOH.H₂O, and SnO₂, In₂O₃, and 85 weight % of H₃PO₄ were mixed together to have a mole ratio of Sn, In, and P to be 0.9:0.1:2-3.

### Manufacturing Example 1

### Manufacturing of Fuel Cell

0.5 g of PtCo/C as a carbon support catalyst (Pt 46.5 wt %, TKK), 0.25 g of polyvinylidene fluoride (5 weight % of an N-NMP solution), and 0.04 g of Sn_{0.7}Na_{0.3}P₂O₇ obtained according to Example 7 were mixed with 2 g of NMP to prepare a slurry for forming a cathode.

The slurry for forming a cathode obtained as described above was coated on a sheet of carbon paper and then dried on a hot plate adjusted at a temperature of about 60° C. for about 1 hour or more. Then, the partially dried resultant was further dried in an oven for 1 hour at 80° C., 30 minutes at 120° C., and 10 minutes at 150° C. to prepare a cathode.

Separately, 0.5 g of PtRu/C (Pt 46.5 wt %, TKK) and 0.25 g of polyvinylidene fluoride (5 weight % of an N-NMP solution) were mixed with 2 g of NMP to prepare a slurry for forming an anode. The slurry for forming an anode obtained as described above was coated on a sheet of carbon paper and dried to prepare an anode.

The electrolyte membrane used was prepared as follows. 50 parts by weight of PPO represented by the Formula below and 50 parts by weight of polybenzimidazole were blended at a temperature of about 80 to about 220° C. to carry out a hardening process.

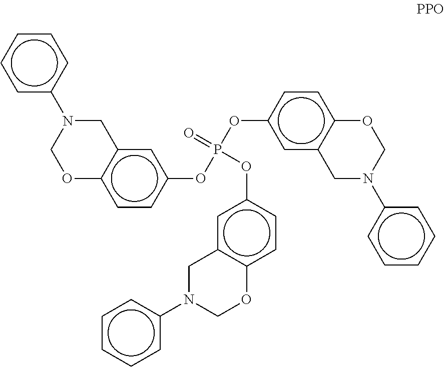

The product obtained after the hardening process was impregnated with 85 weight % of phosphoric acid at 80° C. for about 5 hours to prepare an electrolyte membrane. Here, the amount of the phosphoric acid was 500 parts by weight based on 100 parts by weight of the electrolyte membrane.

The electrolyte membrane was disposed between the cathode and the anode to prepare a fuel cell. Here, the cathode was used without being further impregnated with phosphoric acid and the anode was further impregnated with phosphoric acid at a surface area concentration of 1 mg/cm² and then used. About 250 ccm of air and 100 ccm of hydrogen flowed to the cathode and the anode, respectively to operate a fuel cell at 150° C.

### Comparative Manufacturing Example 1

### Manufacturing Of Fuel Cell

A cathode for a fuel cell and a fuel cell were manufactured in the same manner as in Manufacturing Example 1, except that Sn_{0.7}Na_{0.3}P₂O₇ obtained according to Example 7 was not added and the cathode was impregnated with phosphoric acid at a surface area concentration of 1 mg/cm² and then used, similar to the anode of Manufacturing Example 1.

### Comparative Manufacturing Example 2

### Manufacturing of Fuel Cell

A cathode for a fuel cell and a fuel cell were manufactured in the same manner as in Manufacturing Example 1, except that Sn_{0.9}In_{0.1}P₂O₇ obtained according to Comparative Example 1 was used instead of Sn_{0.7}Na_{0.3}P₂O₇ obtained according to Example 7 when preparing the cathode.

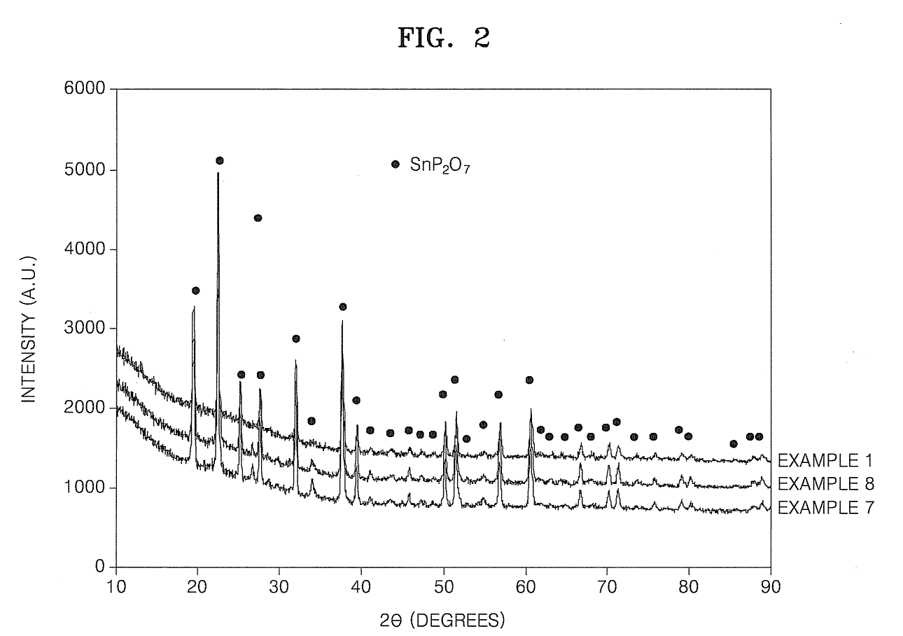

X-ray diffraction analysis was performed for the proton conductors prepared according to Examples 1, 7, and 8 and results are shown in FIG. 2. Referring to FIG. 2, the inorganic proton conductors of Examples 1, 7, and 8 each have the crystal structure of tin phosphate (SnP₂O₇).

Proton conductivity changes of the inorganic proton conductors prepared according to Examples 1, 7, 8, and 9 as a function of temperature were measured. Here, the proton conductivity of materials obtained according to Examples 1, 7, 8, and 9 were evaluated as follows.

The materials obtained according to Examples 1, 7, 8, and 9 were pulverized using a mortar and pressurized by a pressure of 3×10³ kg/cm² to prepare pellets having a diameter of about 12 mm. The pellets were each pressurized between gold-coated blocking electrodes so as to form a conductivity measuring cell. The cells were put in an oven and proton conductivity was measured by using 4-electrodes AC impedance under a frequency of about 0.1-1×10⁶ Hz and an amplitude of about 20 mV by changing the temperature condition and the non-humid air atmosphere condition.

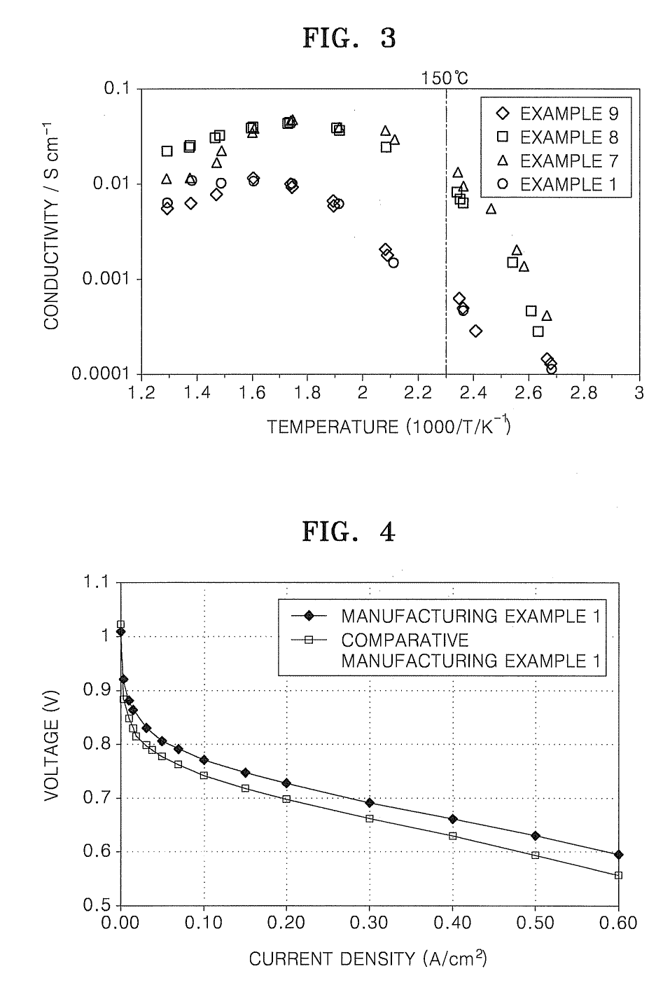

Results of the conductivity measurement are shown in FIG. 3. Referring to FIG. 3, the inorganic proton conductors prepared according to Examples 1, 7, 8, and 9 have excellent conductivity.

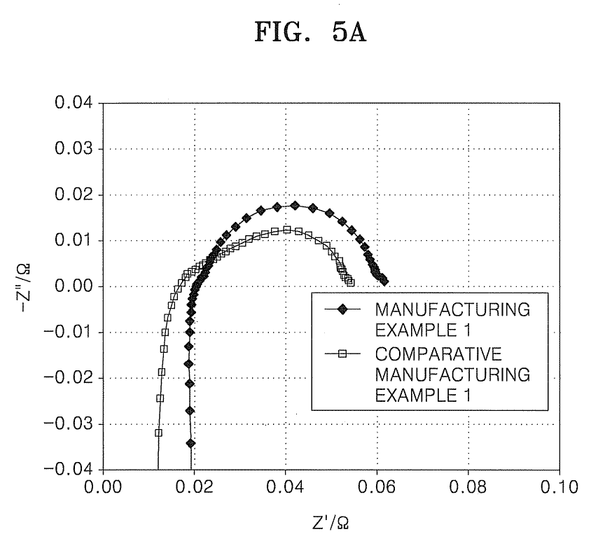

In the fuel cells according to Manufacturing Example 1 and Comparative Manufacturing Example 1, voltage characteristics as a function of current density were evaluated and results thereof are shown in FIG. 4. Referring to FIG. 4, the fuel cell according to Manufacturing Example 1 has a better voltage characteristic than that of Comparative Manufacturing Example 1.

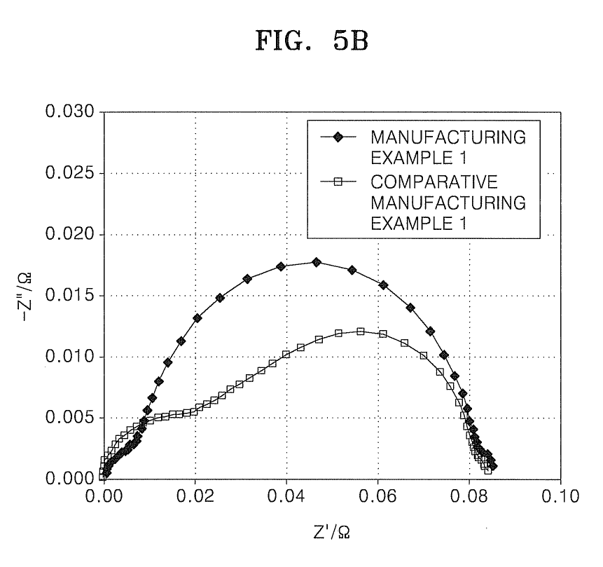

AC impedance analysis was performed for cells of the fuel cells prepared according to Manufacturing Example 1 and Comparative Manufacturing Example 1. Impedance results obtained at 0.2A/cm² and results of reduced impedance in which membrane resistance and inductance were removed are shown in FIGS. 5A and 5B, respectively.

Proton resistance characteristics in the cathodes in the fuel cells prepared according to Manufacturing Example 1 and Comparative Manufacturing Example 1 were analyzed. Here, the proton resistance characteristics in the cathodes were obtained by analyzing resistance components of AC impedance data of FIGS. 5A and 5B through an equivalent circuit. AC impedance was measured under the condition of an amplitude of 10 mV and a frequency of 5 10⁻⁵ Hz at 0.05 Hz with respect to each of current densities of 0.03, 0.05, 0.09, 0.2, 0.3 A/cm² and measured signals were interpreted according to a set equivalent circuit, thereby obtaining values in which resistance characteristics such as proton conductivity in an electrode and charge transfer resistance were changed according to the current density.

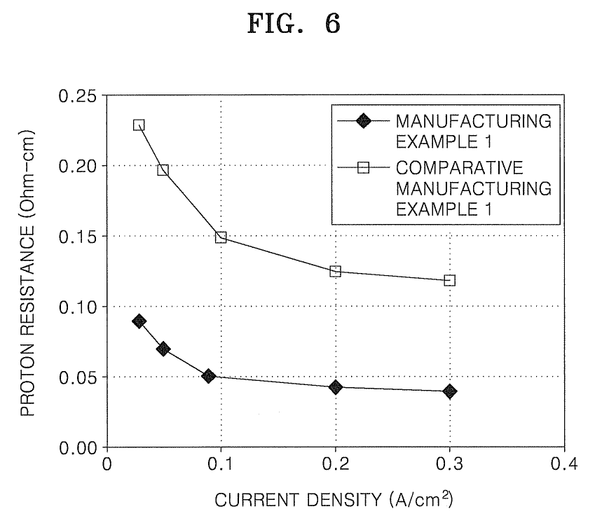

Results of the analysis are shown in FIG. 6. Referring to FIG. 6, proton resistance in the electrode of Manufacturing Example 1 is lower than that of Comparative Manufacturing Example 1.

As described above, according to the one or more of the above embodiments of the present invention, an electrode having excellent proton conductivity and moisture adsorption capability and a fuel cell using the electrode to stably maintain electricity generation performance may be prepared.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electrode for a fuel cell including an inorganic proton conductor represented by Formula 1 below,
M₁₋ₐNₐP₂O₇ [Formula 1]
wherein M is a quadrivalent metal element, N is at least one ion selected from the group consisting of group 1 metal elements and group 2 metal elements, and a is in the range of about 0.01 to about 0.7.

2. The electrode of claim 1, wherein M is at least one ion selected from the group of elements consisting of tin (Sn), zirconium (Zr), tungsten (W), silicon (Si), molybdenum (Mo), and titanium (Ti).

3. The electrode of claim 1, wherein N comprises at least one ion selected from the group of elements consisting of lithium (Li), sodium (Na), potassium (K), cesium (Cs), beryllium (Be), magnesium (Mg), calcium (Ca), strontium (Sr), and barium (Ba).

4. The electrode of claim 1, wherein M is tin (Sn).

5. The electrode of claim 1, wherein a in Formula 1 is in the range of about 0.05 to about 0.5.

6. The electrode of claim 1, wherein the inorganic proton conductor represented by Formula 1 above comprises Sn_{0.7}Li_{0.3}P₂O₇, Sn_{0.95}Li_{0.05}P₂O₇, Sn_{0.9}Li_{0.1}P₂O₇, Sn_{0.8}Li_{0.2}P₂O₇, Sn_{0.6}Li_{0.4}P₂O₇, Sn_{0.5}Li_{0.5}P₂O₇, Sn_{0.7}Na_{0.3}P₂O₇, Sn_{0.7}K_{0.3}P₂O₇, Sn_{0.7}Cs_{0.3}P₂O₇, Zr_{0.9}Li_{0.1}P₂O₇, Ti_{0.9}Li_{0.1}P₂O₇, Si_{0.9}Li_{0.1}P₂O₇, Mo_{0.9}Li_{0.1}P₂O₇, W_{0.9}Li_{0.1}P₂O₇, Sn_{0.7}Mg_{0.3}P₂O₇, Sn_{0.95}Mg_{0.05}P₂O₇, Sn_{0.9}Mg_{0.1}P₂O₇, Sn_{0.8}Mg_{0.2}P₂O₇, Sn_{0.6}Mg_{0.4}P₂O₇, Sn_{0.5}Mg_{0.5}P₂O₇, Sn_{0.7}Ca_{0.3}P₂O₇, Sn_{0.7}Sr_{0.3}P₂O₇, Sn_{0.7}Ba_{0.3}P₂O₇, Zr_{0.9}Mg_{0.1}P₂O₇, Ti_{0.9}Mg_{0.1}P₂O₇, Si_{0.9}Mg_{0.1}P₂O₇, Mo_{0.9}Mg_{0.1}P₂O₇, W_{0.9}Mg_{0.1}P₂O₇, Zr_{0.7}Mg_{0.3}P₂O₇, Ti_{0.7}Mg_{0.3}P₂O₇, Si_{0.7}Mg_{0.3}P₂O₇, Mo_{0.7}Mg_{0.3}P₂O₇, or W_{0.7}Mg_{0.3}P₂O₇.

7. The electrode of claim 1, wherein the inorganic proton conductor is included in a catalyst layer of an electrode incorporating a catalyst.

8. The electrode of claim 1, wherein the inorganic proton conductor is supported or coated on a conductive carbon.

9. The electrode of claim 7, wherein the catalyst is a support catalyst in which a catalyst metal is supported by a carbon-based support and the inorganic proton conductor is supported by the carbon-based support.

10. The electrode of claim 9, wherein the catalyst metal comprises platinum (Pt) or an alloy of platinum (Pt) and at least one metal selected from the group consisting of gold, palladium, rhodium, iridium, ruthenium, tin, molybdenum, cobalt, and chromium, and the catalyst metal is supported by the carbon-based support.

11. The electrode of claim 7, wherein an amount of the inorganic proton conductor is in the range of about 0.05 to about 0.7 parts by weight based on 1 part by weight of the catalyst.

12. The electrode of claim 7, wherein the catalyst layer further comprises a binder.

13. The electrode of claim 7, wherein the amount of the inorganic proton conductor is in the range of about 5 to about 40 parts by weight based on 100 parts by weight of the solid content of the catalyst layer.

14. The electrode of claim 12, wherein the binder comprises at least one polymer selected from the group consisting of poly(vinylidene fluoride), polytetrafluoroethylene, and tetrafluoroethylene-hexafluoropropylene copolymer.

15. The electrode of claim 12, wherein an amount of the binder is in the range of about 0.02 to about 0.05 parts by weight based on 1 part by weight of the catalyst.

16. A fuel cell comprising the electrode for a fuel cell of claim 1.
